(19) United States
(12) Patent Application Publication
(10) Pub. No.: US 2015/0370854 A1
(43) Pub. Date: Dec. 24, 2015

(54) APPROXIMATE QUERY PROCESSING

(71) Applicant: Hewlett-Packard Development Company, L.P., Houston, TX (US)

(72) Inventors: Zhao CAO, Beijing (CN); Li-Mei JIAO, Beijing (CN); Shimin CHEN, Beijing (CN); Min WANG, Beijing (CN); Meng GUO, Shanghai (CN)

(21) Appl. No.: 14/763,793

(22) PCT Filed: Jan. 31, 2013
(86) PCT No.: PCT/CN2013/000107

§ 371 Date: Jul. 27, 2015

(51) Int. Cl. G06F 17/30

(52) U.S. Cl. CPC G06F 17/30448; G06F 17/30528; G06F 17/30498; G06F 17/30864

(57) ABSTRACT

A method for obtaining an approximate answer for a query on a database is provided. A query is converted into a set of sub queries with a canonical form. An approximate answer is generated for each of said sub queries, and approximate answers for the sub queries are combined to obtain an approximate answer for said query.

### BACKGROUND

With the advancing of data collection and data management, data scale has become very large. The massive amounts of data available may lead to expensive query processing times. While some applications may desire to keep a short query response time, such as data mining, decision support and analysis, in some other applications, an approximate answer may be adequate to provide insights about the data.

### BRIEF DESCRIPTION OF THE DRAWINGS

The accompanying drawings illustrate various examples of various aspects of the present disclosure. It will be appreciated that the illustrated element boundaries (e.g., boxes, groups of boxes, or other shapes) in the figures represent one example of the boundaries. It will be appreciated that in some examples one element may be designed as multiple elements or that multiple elements may be designed as one element. In some examples, an element shown as an internal component of another element may be implemented as an external component and vice versa.

FIG. 1 is a block diagram of a system that may obtain an approximate answer for a query on a database according to an example of the present disclosure;

FIG. 2 is a process flow diagram for a method of obtaining an approximate answer for a query on a database according to an example of the present disclosure;

FIG. 3 is a structural diagram of a top-k histogram according to an example of the present disclosure;

FIG. 4 is a process flow diagram for another method of obtaining an approximate answer for a query on a database according to an example of the present disclosure;

FIG. 5 is a block diagram showing a non-transitory, computer-readable medium that stores code for obtaining an approximate answer for a query on a database according to an example of the present disclosure.

### DETAILED DESCRIPTION

Systems and methods for generating an approximate answer for a query on a database are disclosed. As used herein, a database refers to a structured collection of data which can be organized in various ways. Without loss of generality and as used below, a database can be consisted of rows and columns, wherein each row represents a record in the database and each column represents a set of values for an attribute. As used herein, a query refers to an operation used to search in the database for records and/or attributes that satisfy certain conditions or obtain statistics about these records and/or attributes. An example of the systems and methods disclosed herein can divide a query into multiple sub queries and obtain approximate answers for these sub queries, which then can be combined to get an approximate answer for the query. Examples of the systems and methods disclosed herein can provide an accurate approximation for query answering in a short response time and can also support complex queries.

In the following, certain examples according to the present disclosure are described in detail with reference to the drawings.

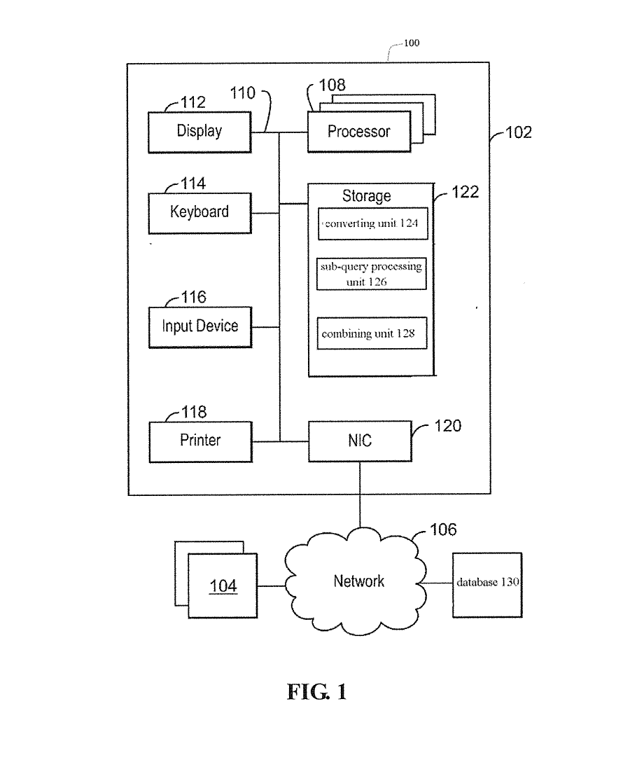

Referring to FIG. 1 now, FIG. 1 illustrates a block diagram of a system that may obtain an approximate answer for a query on a database according to an example of the present disclosure. The system is generally referred to by the reference number 100. Those of ordinary skill in the art will appreciate that the functional blocks and devices shown in FIG. 1 may comprise hardware elements including circuitry, software elements including computer code stored on a tangible, machine-readable medium, or a combination of both hardware and software elements. Additionally, the functional blocks and devices of the system 100 are but one example of functional blocks and devices that may be implemented in an example. Those of ordinary skill in the art would readily be able to define specific functional blocks based on design considerations for a particular electronic device.

The system 100 may include a server 102, and one or more client computers 104, in communication over a network 106. As illustrated in FIG. 1, the server 102 may include one or more processors 108 which may be connected through a bus 110 to a display 112, a keyboard 114, one or more input devices 116, and an output device, such as a printer 118. The input devices 116 may include devices such as a mouse or touch screen. The processors 108 may include a single core, multiple cores, or a cluster of cores in a cloud computing architecture. The server 102 may also be connected through the bus 110 to a network interface card (NIC) 120. The NIC 120 may connect the server 102 to the network 106.

The network 106 may be a local area network (LAN), a wide area network (WAN), or another network configuration. The network 106 may include routers, switches, modems, or any other kind of interface device used for interconnection. The network 106 may connect to several client computers 104. Through the network 106, several client computers 104 may connect to the server 102. The client computers 104 may be similarly structured as the server 102. The network can also connect to a database 130. The database 130 can be any type of database and can also be located in the server 102. The database 130 can hold any kind of data, including, but not limited to, an event log, which is one of the commonly used high dimensional data and may have more than a hundred dimensions.

For example, event logs can be processed and analyzed for purposes such as security management, IT trouble shooting or user behavior analysis. When a user wants to analyze events matching specific criteria, the user may need to create a query to search for events from an event log database. The query can be as simple as a term to match, such as “login” or an IP address; or it can be more complex, such as events that include multiple IP addresses and ports and occur in specific time ranges from devices that belong to a particular device group. The user can specify a set of conditions in a query expression that are used to select or reject an event log.

As an example, a user can specify multiple conditions in a query expression with operators connecting these conditions. For example, a query name=“failed login” AND message!=“success” searches for event logs with a “name” field set to “failed login” and a message field not set to “success”. Various operators can be supported between field conditions, including, but not limited to, string operators such as ‘!=’, ‘=’, ‘>’, ‘<’, ‘<=’, ‘>=’, ‘BETWEEN’, ‘IN’, ‘STARTSWITH’, ‘ENDSWITH’ and ‘CONTAINS’, numeric/timestamp operators such as ‘!=’, ‘=’, ‘>’, ‘<’, ‘<=’, ‘>=’, ‘BETWEEN’, SQL operators such as ‘IS’, Boolean operators such as ‘AND’, ‘OR’, ‘NOT’ and list operator such as ‘IN’.

For sake of convenience, suppose that a query q is to be performed on a large data set, e.g., a high dimensional table R, wherein the table R is composed of rows (i.e. records) and columns (i.e. attributes), as described above. The query q can be expressed using SQL as follows:

select Ax, count (*)
from R
where A_{F}
group by Ax

wherein, count indicates the number of records with Ax being a specific value that are in the table R and A_{F} is the filtering condition with the following recursive definition using Backus Normal Form or BackusNaur Form (BNF):

<A_{F}>::=Aᵢ<Ω>vᵢ

<A_{F}>::=<A_{F}><OP><A_{F}>

<OP>::=AND|OR|NOT

<Ω>::=>|=|>=|<|<=|BETWEEN|CONTAINS|STARTSWITH|ENDSWITH|IN|NOT IN|IS NULL|NOT NULL

As is appreciated, a BNF specification is a set of derivation rules, written as <symbol>::=_expression_, wherein <symbol> is a nonterminal, and the _expression_ consists of one or more sequences of symbols; more sequences are separated by the vertical bar, ‘|’, indicating a choice, the whole being a possible substitution for the symbol on the left. Symbols that never appear on a left side are terminals. On the other hand, symbols that appear on a left side are non-terminals and are always enclosed between the pair < >. The ‘::=’ means that the symbol on the left must be replaced with the expression on the right.

Although different operators may have different semantics for different data types, the processing approach will be similar. Without loss of generality, a query q on a database can be expressed by a general form of q=<A_{F} AND Ax=?>, as described below.

Continuing with FIG. 1, the server 102 may have other units operatively coupled to the processor 108 through the bus 110. These units may include tangible, machine-readable storage media, such as storage 122. The storage 122 may include any combinations of hard drives, read-only memory (ROM), random access memory (RAM), RAM drives, flash drives, optical drives, cache memory, and the like. Storage 122 may include a converting unit 124, a sub-query processing unit 126 and a combining unit 128. The converting unit 124 may convert a query on the database 130 into a set of sub queries with a canonical form. The query can be input by a user through the input device 116 or using the keyboard 114 or the query can be submitted from one of the client computers 104. For example, the canonical form may be disjunctive normal form (DNF), the details of which will be presented below. The sub-query processing unit 126 may generate an approximate answer for each of the sub queries converted by the converting unit 124. The combining unit 128 may combine approximate answers for the sub queries to obtain an approximate answer for the originally input or submitted query.

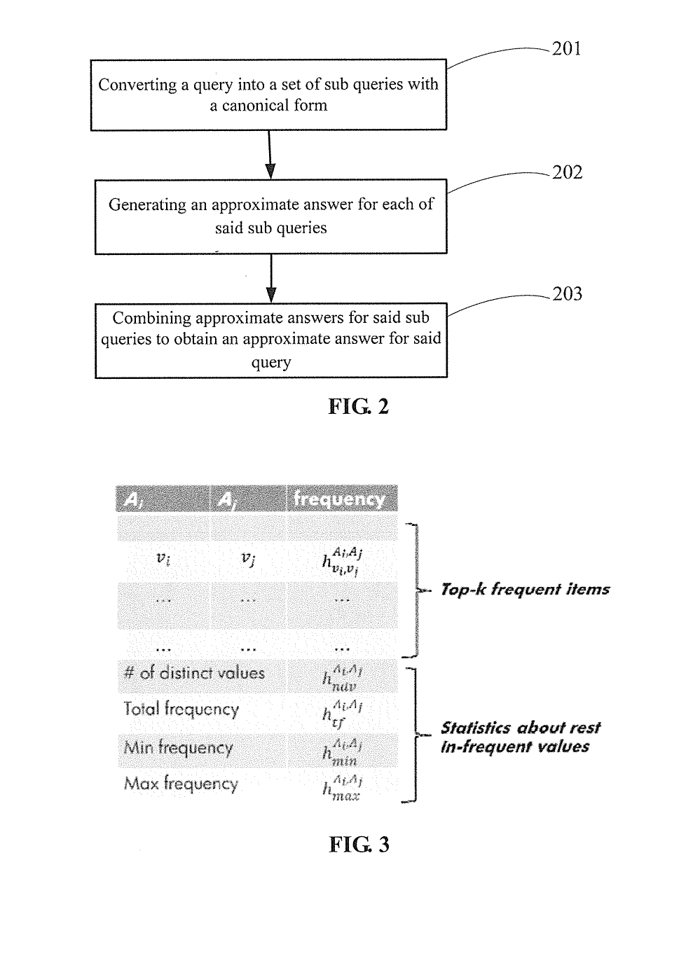

With reference to FIG. 2 now, a process flow diagram for a method of obtaining an approximate answer for a query on a database according to an example of the present disclosure is depicted. A user may input a query on a database. As described above, the query can be a complex one with multiple field conditions connected by various operators. At block 201, the query is converted into a set of sub queries with a canonical form. For example, the canonical form can be a disjunctive normal form (DNF). In Boolean logic, a disjunctive normal form (DNF) is a standardization or normalization of a logical formula which is a disjunction of conjunctive clauses. A logical formula is considered to be in DNF if and only if it is a disjunction of one or more conjunctions of one or more literals. A DNF formula is in full disjunctive normal form if each of its variables appears exactly once in every clause. As in conjunctive normal form (CNF), the only propositional operators in DNF are AND, OR, AND NOT. The NOT operator can only be used as part of a literal, which means that it can only precede a propositional variable. Converting a formula to DNF may involve using logical equivalences, such as the double negative elimination, De Morgan's laws, and the distributive law. Any particular Boolean function can be represented by one and only one full disjunctive normal form.

For example, a query (A1Ωv1 OR A2Ωv2) AND (A3Ωv3 AND NOT A4Ωv4) can be converted to:

(A1Ωv1 AND A3Ωv3 AND NOT A4Ωv4) OR (A2Ωv2 AND A3Ωv3 AND NOT A4Ωv4), wherein “(A1Ωv1 AND A3Ωv3 AND NOT A4Ωv4)” and “(A2Ωv2 AND A3Ωv3 AND NOT A4Ωv4)” are the converted sub-queries.

At block 202, an approximate answer is generated for each of the sub queries. According to an example of the present disclosure, for a sub-query, an approximate answer is generated by utilizing either sampling technique or a top-k histogram associated with the database. For instance, given a sub-query q, samples of the database can be used to answer this sub-query and the result is denoted as process (S,q), wherein S represents a set of samples used to answer the query q. Please be noted that any sampling technique can be used herein and the result of the sub-query can be scaled up based on the sampling ratio and bounded by the total number of records in the database.

A top-k histogram can be built on some predefined column combinations in a database. FIG. 3 illustrates the structure of a top-k histogram according to an example of the present disclosure which is built on column Aᵢ and column Aᵢ of the database. As shown, the top-k histogram includes information about two aspects of a database. The first aspect is the top-k frequent values and their frequencies. For example, the frequency of value combination <vᵢ,vⱼ> of a attribute pair <Aᵢ, Aⱼ> is denoted as hᵥ_{ᵢ}_{,v}_{ⱼ}^{A}^{ᵢ}^{,A}^{ⱼ}. Besides this, the top-k histogram may further include statistical information about the rest infrequent values, such as the total number of distinct infrequent values (h_{ndv}^{A}^{ᵢ}^{,A}^{ⱼ}), their total frequency (h_{tf}^{A}^{ᵢ}^{,A}^{ⱼ}), the minimum frequency of the infrequent values (hₘᵢₙ^{A}^{ᵢ}^{,A}^{ⱼ}), and the maximum frequency of the infrequent values (hₘₐₓ^{A}^{ᵢ}^{,A}^{ⱼ}). Given a histogram h which covers all the attributes in a query q, the query can be answered using the histogram and the result is denoted as process (h,q). It will be understood that FIG. 3 is just an example of a top-k histogram and other variants can be conceived by those skilled in the art in light of the teaching of the present disclosure.

Continuing with FIG. 2, at block 203, after an approximate answer is obtained for each of the converted sub-queries, an approximate answer for the original query is obtained by combining these approximate answers for the sub queries. Since the sub-queries are in form of DNF, the combination of their approximate answer can be based on the law of addition, for example, adding the approximate answers for sub queries together, and/or merging two or more sub queries into a new sub query and then calculating the approximate answer of this new sub query. Specifically, the final approximate answer for a query is obtained as follows:

$$F ( {sq}_{1} ⋁ {sq}_{2} ⋁ {sq}_{3} … ⋁ {sq}_{n} ) = {\sum }_{i = 1}^{n} F ( {sq}_{i} ) - {\sum }_{1 \leq i < j \leq n} F ( {sq}_{i} ⋀ {sq}_{j} ) + {\sum }_{1 \leq i < j < k \leq n} F ( {sq}_{i} ⋀ {sq}_{j} ⋀ {sq}_{k} ) + … + {( - 1 )}^{n - 1} F ( {sq}_{1} ⋀ {sq}_{2} ⋀ … ⋀ {sq}_{n} ) .$$

Wherein, sqᵢ represents i^{th} sub-query and F( ) represents an approximate answer. In each component, such as F(sqᵢΛsqⱼ), the attribute-value constraint pairs are connected through “AND” or “AND NOT” operator. An attribute and value pair can be connected using “=” “!=”, “>”, “>=”, “<”, “<=”, “BETWEEN” “CONTAINS”, “STARTSWITH”, “ENDSWITH”.

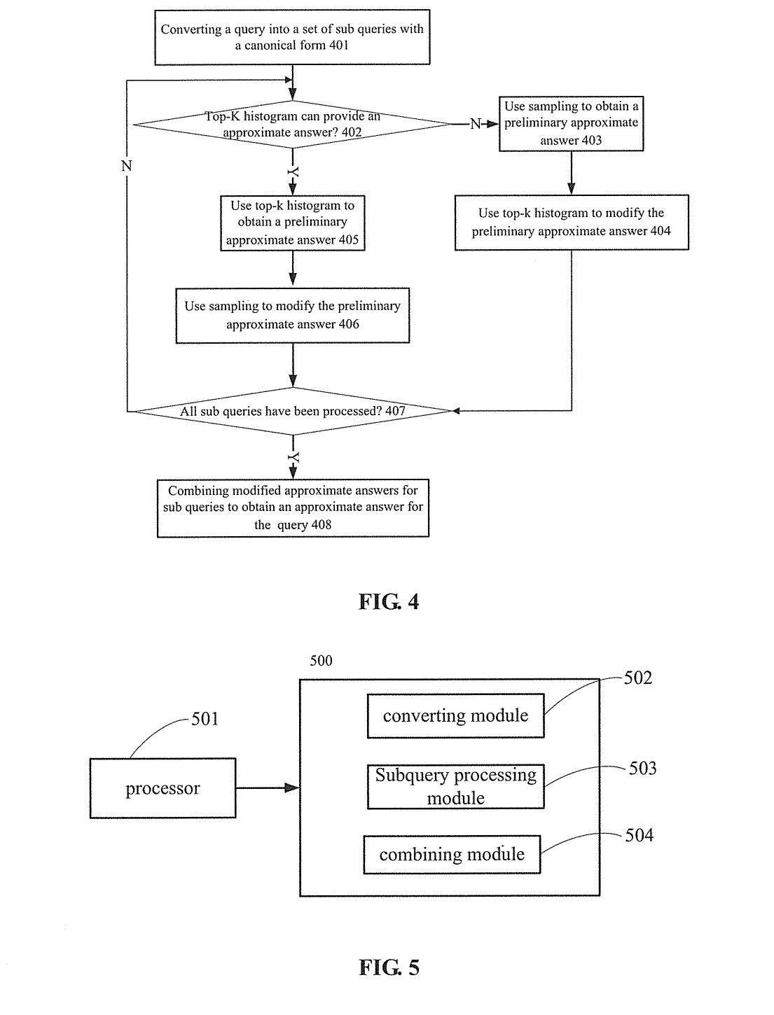

With reference to FIG. 4 now, FIG. 4 is a process flow diagram for another method of obtaining an approximate answer for a query on a database according to an example of the present disclosure. At block 401, a query on a database is converted into a set of sub queries with a canonical form. At block 402, it is determined for each sub-query whether or not an approximate answer can be obtained directly according to a top-k histogram for the database, which may be pre-built by the user. If it is determined that the sub-query can be answered directly using a top-k histogram, then the method proceeds to block 405, where the top-k histogram is used to get a preliminary approximate answer for the sub query. Then, at block 406, sampling in a database is used to modify the preliminary approximate answer in order to obtain a modified approximate answer for the sub query. If at block 402, it is determined that the sub-query cannot be answered directly using a top-k histogram, then the method proceeds to block 403, where sampling is used to obtain a preliminary approximate answer for the sub query. Then at block 404, the top-k histogram is used to modify the preliminary approximate answer in order to obtain a modified approximate answer for the sub query. At block 407, it is determined whether all the converted sub-queries have been processed or not. If yes, the method proceeds to block 408, where these approximate answers for the sub queries are combined to obtain an approximate answer for the original query. If there is still any more sub-queries to be answered, then the method returns to block 402 and repeats the above process.

By way of example and not limitation, processing approaches for some operators according to methods described above are described below. For convenience, operators which have similar processing approach are grouped together.

For AND operator, a query has the following form: q=<Aᵢ=vᵢ, AND . . . , AND Aⱼ=vⱼ AND Aₓ=?>

If there exists a histogram h as shown in FIG. 3 that covers all the attributes in the query q, i.e., this query can be directly answered using the histogram h, then records that satisfy the filter conditions can be first extracted from the top-k frequent items and this preliminary result is denoted as X=process(h,q). Next, another answer Y=process(S,q) can be obtained using samples, and then this answer can be modified by using the statistics of the rest values other than top-k items in the histogram h. For each record y in Y and y is not in X, the frequency of y is modified as follows and then record y is put into the answer set X:
if y.freqnency>hₘₐₓ, then y.freqnency=hₘₐₓ;
If y.frequency<hₘᵢₙ, then y.freqnency=hₘᵢₙ;
   Wherein, hₘₐₓ and hₘᵢₙ represent the maximum and minimum frequencies of the rest non-top-k values respectively. The answer set X will be the final query answer.
   If there does not exist a histogram h that covers all the attributes in the query q, i.e., this query cannot be directly answered using the histogram h, then a preliminary result Y=process(S,q) can be obtained using samples, and then this preliminary result Y can be modified by using the top-k histogram. For example, for each histogram h that includes some of the attributes in the query q, for each record y in Y, it can be checked if the attribute values exist in the top-k frequent values. If the attribute values exist in the top-k frequent values, another answer Y′=process(h,q) can be obtained using the top-k frequent items, and then Y′ can be grouped and aggregated based on the overlapped attribute, resulting in only one record y′. If the frequency of record y′ is less than the frequency of record y, then the frequency of record y can be set to be the frequency of record y′.

On the other hand, if no attribute value exists in the top-k frequent values, then only the frequency of record y can be modified according to the statistical information about the rest non-top-k values in the histogram, as follows:
if y.frequency>hₘₐₓ, then y.frequency=hₘₐₓ
if y.frequency>hₘᵢₙ, then y.frequency=hₘᵢₙ

For operator OR, a query can be one of the following two forms: q=<A_{F} OR Aₓ=?> and q=<subquery OR Aᵢ=vᵢ) AND Aₓ=?>.

For the former case, results of sub-queries sq1=<A_{F}> and sq2=<Aₓ=?> are calculated. These results are then unioned and grouped and aggregated based on Ax. For the latter case, the query is equivalent to q=<(subquery AND Aₓ=?) OR (Aᵢ=vᵢ AND Aₓ=?)>. The query processing is similar to the former case: calculate the result of sub-query sq1=<subquery AND Aₓ=?>; calculate the result of sub-query sq2=<Aᵢ=vⱼ AND Aₓ=?>; union the result of sq1 and sq2, and then group and aggregate based on Aₓ.

In both cases, if record y1 in the result of sq1 and record y2 in the result of sq2 have the same attribute value, then the lower bound frequency of this record is max(y_{lower}, z_{lower}) and the upper bound frequency of this record is max(yᵤₚₚₑᵣ, zᵤₚₚₑᵣ), wherein yᵤₚₚₑᵣ and glower are the upper bound and lower bound of the frequency of record y1 respectively, Zᵤₚₚₑᵣ and Z_{lower} are the upper bound and lower bound of the frequency of record y2 respectively and max ( ) gets the maximum value of two values.

For operators NOT and !=, a query is in the following form:

q=<subquery NOT Aⱼ=vⱼ AND Aₓ=?>
It is equivalent to:
q=<subquery NOT Aⱼ!=vⱼ AND Aₓ=?>

If there exist histograms h and h′ that can cover all the attributes of q and q′=<subquery AND Aₓ=?> respectively, then a result Y=process(h′, q′) can be obtained first by using the top-k frequent items in h′; and then, for each y in Y, y.frequency-process (h,q|Aj=y.Aj), which is a record, is put into the answer set. If y and z have bound as yᵤₚₚₑᵣ, y_{lower}, zᵤₚₚₑᵣ and z_{lower} respectively, yᵤₚₚₑᵣ=yᵤₚₚₑᵣ−z_{lower} and y_{lower}=y_{lower}−zᵤₚₚₑᵣ are returned.

Otherwise, if there does not exist histograms h and h′ that can cover all the attributes of q and q′, and if there exists a histogram h′ that can cover all the attributes of q′=<subquery AND Aₓ=?>, then a result Y=process(h′, q′) can be obtained by using the top-k frequent items in h′; a result Z=process(S,q) can be obtained by using samples and for each y in Y, y.frequency-Z(Aj=y.Aj) is put into the answer set.

However, if there does not exist a histogram h′ that can cover all the attributes of q′, then the answer process(S,q) is returned using samples directly.

For operators >=, <, <=, BETWEEN, CONTAINS, STARTSWITH, and ENDSWITH, a query is in the following form:
q=<subquery AND Aⱼ OP vⱼ AND Aₓ=?>
   where OPε{>,< >=,<=,BETWEEN,CONTAINS,STARTSWITH,ENDSWITH}.

The query processing can first get X=process(S,q) using samples; then for each sub-query sq of q in the form of <Aⱼ=vⱼ, AND . . . AND Aᵢ=vᵢ>, if there exists a histogram h that covers all the attributes of sq, m=process(h,sq) can be obtained; then if there is any x in X, and x.frequency >m, set x.frequency=m. X will be returned as the final result.

For operator IN, a query is in the form of:
q=<subquery AND Aⱼ in (vᵢ, . . . , vⱼ) AND Aₓ=?>.

It is equivalent to:
q=<subquery AND (Aⱼ=v₁ OR . . . OR Aⱼ=vⱼ) AND Aₓ=?>
   =<(subquery AND Aⱼ=v₁ AND Aₓ=?)
      OR . . . OR
      (subquery AND Aⱼ=vⱼ AND Aₓ=?)>

The query processing can first compute the result of each component and then sum the results of each component together, as follows:
F(q)=F(subquery AND Aⱼ=v₁ AND Aₓ=?)+
+F( . . . )+
F(subquery AND Aⱼ=vⱼ AND Aₓ=?)

For operator NOT IN, a query is in the form of:
q=<subquery AND AⱼNOTIN (v₁, . . . , vⱼ) AND Aₓ=?>.

It is equivalent to:
q=<subquery AND Aⱼ!=v₁, AND, . . . , AND Aⱼ!=vⱼ) AND Aₓ=?>

The query process will be similar to operator AND, and will not be described herein.

For operator IS NULL/IS NOT NULL, a query is in the form of:
q=<subquery AND Aⱼ IS NULL AND Aₓ=?>
or q=<subquery AND Aⱼ IS NOT NULL AND Aₓ=?>

NULL can be considered as a special value, and the query is equivalent to:
q=<subquery AND Aⱼ=NULL AND Aₓ=?>
or q=<subquery AND Aⱼ!=NULL AND Aₓ=?>

The query processing is similar to operators = and !=, and will not be described herein.

As described above, examples of the present disclosure for providing an approximate answer for a query can generate more accurate approximation and also can support a variety of complex operators and complex queries.

With reference to FIG. 5 now, FIG. 5 illustrates a block diagram showing a non-transitory, computer-readable medium that stores code for obtaining an approximate answer for a query on a database according to an example of the present disclosure. The non-transitory, computer-readable medium is generally referred to by the reference number 500.

The non-transitory, computer-readable medium 500 may correspond to any typical storage device that stores computer-implemented instructions, such as programming code or the like. For example, the non-transitory, computer-readable medium 500 may include one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disks, compact disc drives, digital versatile disc drives, and flash memory devices.

A processor 501 generally retrieves and executes the computer-implemented instructions stored in the non-transitory, computer-readable medium 500 for obtaining an approximate answer for a query on a database. At block 502, a converting module may convert said query into a set of sub queries with a standard form. At block 503, a sub-query processing module may generate an approximate answer for each of the sub queries. At block 504, a combining module may combine approximate answers for the sub queries to obtain an approximate answer for the query.

From the above depiction of the implementation mode, the above examples can be implemented by hardware, software or firmware or a combination thereof. For example the various methods, processes, modules and functional units described herein may be implemented by a processor (the term processor is to be interpreted broadly to include a CPU, processing unit, ASIC, logic unit, or programmable gate array etc.) The processes, methods and functional units may all be performed by a single processor or split between several processors. They may be implemented as machine readable instructions executable by one or more processors. Further the teachings herein may be implemented in the form of a software product. The computer software product is stored in a storage medium and comprises a plurality of instructions for making a computer device (which can be a personal computer, a server or a network device, etc.) implement the method recited in the examples of the present disclosure.

The figures are only illustrations of an example, wherein the modules or procedure shown in the figures are not necessarily essential for implementing the present disclosure. Moreover, the sequence numbers of the above examples are only for description, and do not indicate an example is more superior to another.

Those skilled in the art can understand that the modules in the device in the example can be arranged in the device in the example as described in the example, or can be alternatively located in one or more devices different from that in the example. The modules in the aforesaid example can be combined into one module or further divided into a plurality of sub-modules.

What is claimed is:

1. A method for obtaining an approximate answer for a query on a database, comprising:
converting said query into a set of sub queries with a canonical form;
generating an approximate answer for each of said sub queries; and
combining approximate answers for said sub queries to obtain an approximate answer for said query.

2. The method recited in claim 1, wherein said canonical form is a disjunctive normal form (DNF).

3. The method recited in claim 1, wherein generating an approximate answer for each of said sub queries comprises utilizing either sampling in said database or a top-k histogram associated with said database to generate an approximate answer for each of said sub queries.

4. The method recited in claim 2, wherein said sub queries are connected by an operator OR, and said combining is based on the law of addition.

5. The method recited in claim 3, wherein utilizing either sampling in said database or a top-k histogram associated with said database to generate an approximate answer for each of said sub queries further comprises:
if an approximate answer for a sub query can be obtained directly according to the top-k histogram, then using the top-k histogram to get a preliminary approximate answer for said sub query, and using sampling to modify said preliminary approximate answer in order to obtain an modified approximate answer for said sub query; and
if an approximate answer for a sub query cannot be obtained directly according to the top-k histogram, then using sampling to obtain a preliminary approximate answer for said sub query, and using the top-k histogram to modify said preliminary approximate answer in order to obtain an modified approximate answer for said sub query.

6. The method recited in claim 5, wherein said combining comprises combining said modified approximate answer for each sub query to obtain an approximate answer for said query.

7. The method recited in claim 3, wherein said top-k histogram comprises statistical information about the rest values except top k items.

8. A system for obtaining an approximate answer for a query on a database, said system comprising:
a processor that is adaptable to execute stored instructions; and
a memory device that stores instructions, the memory device comprising processor-executable code, that when executed by the processor, is adaptable to:
convert said query into a set of sub queries with a canonical form;
generate an approximate answer for each of said sub queries; and
combine approximate answers for said sub queries to obtain an approximate answer for said query.

9. The system recited in claim 8, wherein said canonical form is a disjunctive normal form (DNF).

10. The system recited in claim 8, wherein said memory device stores processor-executable code, and said processor-executable code is adaptable to generate an approximate answer for said sub queries by:
utilizing either sampling in said database or a top-k histogram associated with said database to generate an approximate answer for each of said sub queries.

11. The system recited in claim 9, wherein said sub queries are connected by an operator OR and said combination is based on the law of addition.

12. The system recited in claim 10, wherein said memory device stores processor-executable code, and said processor-executable code is adaptable to utilize either sampling in said database or a top-k histogram associated with said database to generate an approximate answer for each of said sub queries by:
if an approximate answer for a sub query can be obtained directly according to the top-k histogram, then using the top-k histogram to get a preliminary approximate answer for said sub query; and using sampling to modify said preliminary approximate answer in order to obtain an modified approximate answer for said sub query; and
if an approximate answer for a sub query cannot be obtained directly according to the top-k histogram, then using sampling to obtain a preliminary approximate answer for said sub query, and using the top-k histogram to modify said preliminary approximate answer in order to obtain an modified approximate answer for said sub query.

13. A non-transitory, computer-readable medium, comprising code configured to direct a processor to:
convert said query into a set of sub queries with a canonical form;
generate an approximate answer for each of said sub queries; and
combine approximate answers for said sub queries to obtain an approximate answer for said query.

14. The non-transitory, computer-readable medium recited in claim 13, wherein said canonical form is a disjunctive normal form (DNF).

15. The non-transitory, computer-readable medium recited in claim 13, wherein said non-transitory, computer-readable medium comprises code configured to direct a processor to generate an approximate answer for said sub queries by:
utilizing either sampling in said database or a top-k histogram associated with said database to generate an approximate answer for each of said sub queries.
